(19) United States
(12) Patent Application Publication
(10) Pub. No.: US 2020/0219375 A1
(43) Pub. Date: Jul. 9, 2020

(54) METHOD AND APPARATUS FOR MONITORING BUILDING ALARM SYSTEMS

(71) Applicant: Steven Walter PEROS, Oakville, Ontario (CA)

(72) Inventor: Steven Walter PEROS, Oakville, Ontario (CA)

(21) Appl. No.: 16/626,454

(22) PCT Filed: Jun. 20, 2018
(86) PCT No.: PCT/CA2018/050746

§ 371 Date: Dec. 24, 2019

Related U.S. Application Data
(60) Provisional application No. 62/527,381, filed on Jun. 30, 2017.

(51) Int. Cl. G08B 21/18; G08B 21/20; G08B 21/16; G08B 25/08; G08B 23/00

(52) U.S. Cl. CPC G08B 21/182; G08B 21/20; G08B 23/00; G08B 25/08; G08B 21/16

(57) ABSTRACT

A building monitoring system that provides detection of anomalous conditions in the building, including water leaks, or the like. The system includes a central unit operatively connected to a plurality of sensor devices which are used to detect the anomalous condition. The central unit alerts the user of the anomalous condition, and take action to minimize the damage from the condition, such as activating a water shutoff valve or the like. The system also preferably includes a system for actively monitoring the status of the sensors to determine that the sensor, and the overall monitoring system is working properly.

### FIELD OF THE INVENTION

The present invention relates to the field of monitoring systems, and in particular, to a system which can provide a building alarm system, but also to a building alarm monitoring systems which ensure that the alarm system itself is monitored on an on-going basis.

### BACKGROUND OF THE INVENTION

Maintaining and protecting a building or building complex can be difficult and costly. This includes building and building complexes such as residential dwellings, including houses, town houses, condominium dwellings, apartment buildings, and the like, institutional buildings such as hospitals or schools, industrial buildings such as office buildings, factory buildings, warehouses, and the like.

Conditions such as fires, gas leaks, etc. can clearly be a danger to the occupants and to the building structure. Other malfunctions, such as water leaks in roofs, plumbing, etc. are not necessarily dangerous for the occupants, but can nevertheless cause considerable damage. As such, numerous systems are known in the art to monitor one or more of these conditions in order to provide an alarm that alerts a user of the existence of one or more of these unwanted conditions. For example, many buildings are currently fitted with some type of smoke detector to provide an alarm if smoke is detected in the building. However, in a more general example, these systems can be used to alert the building owner or the like, of potentially dangerous or costly conditions such as, for example, water leaks or disconnects, gas leaks, temperature variations, lighting malfunctions, and the like in a building.

A variety of alarm systems are known, and a number of these include complex systems which have alarms for a number of different undesirable conditions. However, systems to monitor the alarm system components, such as the various component elements themselves, including various sensors, connector systems, alarm components, and the like, are less well known. Clearly though, continual monitoring of these component elements can be of value since during an event, such as a water leakage situation, an unknown previous failure of a water sensor or its connection to the alarm system, can lead to significant damages regardless of the status and overall sophistication of the primary alarm system. Accordingly, detection of a failed or inoperative alarm system component can be crucial in avoiding unnecessary damages.

Further, the prior art systems merely monitor the current status of the building or building complex, and are typically not programmed to detect building services usages, such as water consumption, and adjust the building services accordingly. This could be related to actual usage of the building services, or based on time and/or date considerations. Providing a monitoring system which provided these features would also be of benefit to the industry.

To overcome these difficulties, it would be advantageous to provide an alarm system monitoring approach which ameliorates and/or eliminates the damages resulting from a failed alarm system component.

Further, it would be advantageous to provide a monitoring system which routinely tested the various alarm system components to ensure that each component was operating within acceptable or normal operating parameters.

Still further, it would be advantageous to provide a monitoring system which was capable of being programmed, or being adapted to record building usage, and modify the building services accordingly.

### SUMMARY OF THE INVENTION

The present invention solves these and other problems by providing a monitoring system which monitors and tests the condition of the various alarm detection sensors, in order to provide feedback on the operational status of the alarm sensors, as well as to monitor their connectivity to the alarm system.

The present invention also preferably provides a monitoring system which observes and records the usages of the monitored building service, in order to modify the provision of the building service. This can also include a feature to program the monitoring system to limit access to a building service depending on time, date and/or recent usage.

As such, in a first aspect, the present invention provides a building alarm monitoring system comprising a central unit having a processor unit, at least one sensor unit, and at least one anomalous-condition response device, wherein the sensor unit is:

adapted to measure a set condition for the building;

determine when an anomalous measurement is detected; and

notify the central unit of the anomalous condition, and where said central unit is adapted to receive a notice from the sensor regarding the anomalous condition, evaluate said anomalous condition to establish if an alarm condition exist, and if the anomalous condition is outside of an acceptable range of parameters so that an alarm condition exists, notify a user of the anomalous condition, and activate at least one anomalous-condition response device.

In a preferred embodiment, the anomalous condition is a water leak, and thus, the system preferably comprises a moisture sensor and/or a water level sensor; a connecting system to connect said sensors to said central unit; a processor which acts as said central unit, wherein said central unit is configured to collect sensor readings from said sensors; analyse said sensor readings to determine whether a water leak has been detected; and a reporting device so that when a water leak has been detected by having a moisture level and/or a water level above a threshold valve, said central unit will report said water leak as an anomalous condition to a user as an alarm, and further activate said anomalous-condition response device.

The connecting system is a wireless connection, or a hard-wired connection which can utilize the building wiring and/or can be established by using a local network established in said building.

The moisture sensor and/or water level sensor is preferably placed proximate to a water usage device such as, for example, a water supply pipe, a plumbing feature, a water heater, a toilet, or a water drain. Moisture sensors can be used to detect the leak of water, or even to detect levels of high humidity which might require a fan to be start. Water level detectors can be used to detect high water levels in, for example, a sump pump area.

While the appropriate action to be taken once an anomalous condition is detected can vary, typically, when a water leak is detected, the anomalous-condition response device is a water shutoff valve, and the central unit is configured to close the water shutoff valve. As such, the water shutoff valve preferably includes a device for receiving instructions from the central unit to close the water shutoff valve when a leak is detected.

The anomalous condition can also include detection of an expected or unexpected use of water. This might be a low water usage event in an office building over a weekend, or a low water usage event in a house or building that is currently vacant. In this case, the user is notified, and the system activates the water shutoff valve to avoid any possibility of a water leak. The system might also be used to detect a high use of water at an unexpected time, to detect, for example, the activation of a building sprinkler system at an incorrect time, or to indicate that a plumbing device has been left running (e.g. a tap in a sink, a toilet running, or the like).

The system can also be used to detect an electrical failure, and activate the appropriate response. This could include starting an electrical generator or the like, but could also include activating the water shutoff valve to prevent a water leak during the electrical failure.

During the electrical failure, the system including the water shutoff valve can be battery operated.

The anomalous condition might also be a gas leak which can be detected by a flammable gas sensor. In this arrangement, the central unit causes a gas shutoff valve to activate.

Further, the anomalous condition might be a refrigeration malfunction detected by, for example, a temperature sensor. This might be used to identify a failure of a heating or cooling device in the building, but might also indicate a failure of a refrigerator, or a refrigeration system, or a fan. While the primary response to this type of anomalous condition would be to notify the user with an alarm, the system can also try to reset or restart the appropriate device, engage alternative devices (e.g. use other fans), or use an electrical switch to disconnect power to said refrigeration device.

The system preferably notifies the user of an alarm by telephone, cellular telephone, text messaging, by pager, by email, by Internet instant messaging, or any other similar systems.

Additionally, the central unit of the system of the present invention also preferably includes a monitoring feature which monitors the status of said sensor unit, the device used to notify the user of the anomalous condition, and the anomalous-condition response device. Thus, the sensors used in the practise of the present invention preferably includes systems which are adapted to respond to signals from the central unit, in order to confirm that the sensor units are operationally functional.

Moreover, the present invention provides a method for monitoring an alarm system, of the type herein described. As such, in a further aspect, the present invention provides a method for monitoring an alarm system comprising:

providing a building central alarm unit, at least one sensor unit, and at least one anomalous-condition response device, wherein the central alarm unit is operatively connected to the sensor units and the anomalous-condition response devices;

monitoring a set condition for the building;

determining when an anomalous measurement is detected;

notifying the central unit of the anomalous condition,

receiving, at the central unit, a notice from the sensor unit regarding the anomalous condition,

evaluate, at said central unit, said anomalous condition, to determine if said anomalous condition is outside of an acceptable range of parameters, and thus establish an alarm condition,

if the anomalous condition is outside of an acceptable range of parameters so that an alarm condition is established, notify a user of the alarm condition, and activate at least one of the anomalous-condition response device.

The monitoring system of the present invention is typically provided as part of, or together with, an alarm system which has one or more sensor units connected to a central unit that communicates with the sensor units. The central unit of the monitoring system can also be added to an existing alarm system wherein the sensors are in contact with an alarm system unit, and the central unit and alarm unit are operatively connected.

The overall functionality of the monitoring system of the present invention is preferably included as a processor as part of a computerized device which is connected to, or part of, the central unit.

As in known alarm systems, once an alarm condition has been detected in any one of the alarm systems, the alarm system communicates with the user through any selected medium. For some alarms, this can include passive alerts which merely identify the anomalous sensor or condition on a control panel, or the like. More preferably, however, the monitoring system includes an active alert system which acts to alert the user to an anomalous condition in one or more alarm system components, and preferably provide data regarding the anomalous alarm system component condition. In this more active system, the system can, either through its own monitoring unit, or the central unit, contact the user, or other responsible person, by at least one of a plurality of techniques, including techniques such as by telephone messages, pager alerts, cellular telephone messages, e-mails, SMS system messages, text messaging, and the like.

The monitoring system of the present invention is therefore preferably part of, or added to, an existing alarm system.

In a preferred embodiment however, the monitoring system of the present invention also acts to address the cause of the alarm condition. For example, if the alarm is from a water sensor detecting a water leak in part of the building, the monitoring system of the present invention acts to alert the user, and to also turn off the water to that part of the building. This second stage can be accomplished using a computer controlled water valve controlled by the monitoring system.

Further, modification of the building services is also contemplated in the present invention, as part of the monitoring function. For example, the system of the present invention can monitor usage of a building or part thereof to determine the use of building, and adjust the building systems according. This can include time and date considerations. Thus, if the system detects that water has not been used for a set time period, or the system is programmed to be aware that the building is not used overnight, or on weekends, the water to the building (other than safety sprinklers and the like) can be turned off. This would prevent water damage from a leaking pipe or the like, when no one was present in the building.

As such, in an additional preferred embodiment, when the monitoring system detects that a building service has not been used for longer than a set time period, or when the system notes that time or date considerations indicate that the service is predicted not be used, the building service can be shut off, or otherwise adjusted. This includes, adjusting the temperature, turning-off or adjusting lighting, shutting off water to selected areas, and the like.

In a still further preferred embodiment, the monitoring system of the present invention also actively tests the functionality of the various alarm component part in order to detect whether any of the sensor units is not operating within acceptable operating parameters. This can also be used to check whether each sensor unit is still operatively connected to the central unit. This is used to determine whether the sensor has malfunctioned, or to determine whether the wired or wireless connection to the central unit has been compromised.

As a result, the monitoring system of the present invention provides significant advantages over systems which merely detect and advise the user of an alarm condition.

It should be noted that, in a preferred embodiment, the monitoring system of the present invention is primarily directed to monitoring and controlling water usage and detecting water leakage within a building. However, the system can be used to monitor the alarm system and the alarm system components of other systems. Thus, the monitoring system of the present invention is preferably expandable to also monitor and address issues related to HVAC components, heating cables, fresh air make-up systems, garage doors, security systems, carbon monoxide sensors, elevators, sump pumps, and/or to also provide operating efficiencies to various building components, include lighting and motors.

Of particular concern in the practise of the present invention, is the detection and response to water leakage. Detecting water leakage has always been somewhat elusive, insomuch that current systems are typically limited by range, and by extension connectivity and reliability, cumbersome in that they require electricity or some other type of “hard connection”, or functionality in that the majority of current systems are typically limited to only a few devices, and these devices merely provide notification of an event.

The monitoring system of the present invention however, provides a solution to fit any environment, with no limitations to distance or even connectivity as it preferably harnesses the power of a local building network, such as Wi-Fi, and/or the buildings internal electrical system to amplify the signal by effectively creating an internal intranet in each home or building. Additionally, the system of the present invention is continually checking in with all sensors to ensure they are functioning properly. Moreover, the system of the present invention preferably includes at least one system for shutting off the water supply. This is preferably accomplished using one or more remotely controlled valves which can be individually activated by the monitoring system. As a result, the system can shut off water to all or part of a building in the event of a leak, or sensor failure. Further, the system can also be programmed to shut down the water to the building when it is vacant (with the exception of water to fire sprinklers, and the like).

Additionally, the system of the present invention can be operated off of battery power, or arranged in a normally closed position, so that if regular power is interrupted, by way of a tripped breaker, or by a power outage, the system will automatically shut down the water in real time.

Still further, each system preferably has a back-up to the back-up, allowing for the user to manually over-ride the system, if desired, during power outages.

As a result, by providing a system that is constantly scanning all of its sensors, notifying and reacting in real time, the present invention allows those owning a building to know that they are truly protected from water damage at all times.

In one embodiment, the sensor system includes a number of sensor units located throughout a building that sense conditions and report anomalous results back to a central reporting station. The sensor units measure conditions that might indicate a fire, water leak, gas leak, temperature variation, etc. The sensor units report the measured data to the central unit whenever the sensor unit determines that the measured data is sufficiently anomalous to be reported. The central unit can notify a responsible person such as, for example a building manager, building owner, private security service, etc.

The sensors used in the present system can be hard wired to the central unit, or can draw power from the local power system. Preferably however, the sensor is a battery-operated sensor unit that can detects an anomalous condition caused by, for example, smoke, temperature, humidity, moisture, water, water temperature, carbon monoxide, natural gas, propane gas, other flammable gases, radon, poison gasses, etc. The sensor unit is placed in a building, apartment, office, residence, etc., and preferably connected to the central unit through a local network such as a Wi-Fi connection, or through some other type of wireless system (e.g. Bluetooth, or the like).

In order to conserve battery power, the sensor is normally placed in a low-power mode, but even in low power mode, the sensor unit takes regular sensor readings and evaluates the readings to determine if an anomalous condition exists. If an anomalous condition is detected, then the sensor unit “wakes up” and begins communicating with the central unit or with a repeater.

At programmed intervals, the sensor can be contacted by the central unit to determine whether the sensor is functioning properly, and is still connected to the system. This can occur on a regular basis and the time period between establishing contact with the central unit can vary depending on the nature of the sensor. Preferably, the central unit contacts the sensor in a time period of between every 30 seconds to every hour. More preferably, the central unit contacts the sensor every 1 minute to 15 minutes, and most preferably, the central unit contacts the sensor every 2 to 5 minutes.

The central unit is configured to receive measured sensor data from a number of sensor units. Where necessary, the sensor information can be relayed through one or more repeater units. The central unit also sends commands to the repeater units and/or sensor units. In one embodiment, the central unit can include a diskless PC that runs off of a CD-ROM, flash memory, DVD, or other read-only device, etc. When the central unit receives data from a sensor indicating that there may be an anomalous condition (e.g., a fire or excess smoke, temperature, water leak, flammable gas leak, etc.) the central unit will attempt to notify a responsible party (e.g., a building manager) by several communication channels (e.g., telephone, Internet, pager, cell phone, etc.). In one embodiment, the central unit sends instructions to a further device, such as a water control valve, power switch, fan, or the like, to take an appropriate action such as shutting off the water supply, disconnecting the electrical power, turning on fans, or the like.

Accordingly, it is a principal advantage of the present invention to provide a system which works in a manner that it would sense an anomalous condition, notify the user, and react in real time, with all of the various attributes listed above, and which would ensure connectivity in any environment with virtually any permutation of quantity and distance, and being able to work under extreme conditions, such as no power.

The system of the present invention also preferably includes a monitoring system to determine whether the system was in an operational condition. This includes the sensors, and problems with the sensors typically would occur in, for example, four unique situations, namely:
1) The power to the unit (and not the entire building) stops;
2) The unit stops working (crashes);
3) The connectivity to the central unit internet is broken (for example, the wireless connection to the central unit is lost); or
4) The unit is physically removed from the location

All existing system fail to address any of these four potential shortcomings, which are integral to ensuring the system is actually alive and doing its job.

As such, in a preferred embodiment, the system of the present invention preferably includes an approach wherein an outside source, such as the central unit, “pings” the unit at consistent intervals (set up for every 3 minutes). As long as a suitable response is received back in response to the ping, the sequence continues at the same interval.

When a ping is disrupted, which would effectively indicate a scenario described above, an alert is sent to a program in the central unit, which receives the alert so that the system can identify which site has originated the alert.

In order to eliminate spurious results caused by normal day to day variations, the program repeats the ping again after a suitable time, such as after 3 to 10 minutes, During this period, the system is monitoring the ping has now received a suitable response. If a suitable response to the ping is not received, the central unit can send a reset command to the sensor in an attempt to restore normal functionality.

If the follow up ping and/or sensor reset does not work, the program sets off an alert to the user to check on the sensor.

In use, the primary advantage of the system of the present invention, is the detection of water leaks. Strategically placed moisture sensors monitor and react in real time to water failure, which can mitigate damage to the building by notifying the user of an event and simultaneously shutting down the main water supply. By using the building's existing electrical system as part of the connection system between the sensors and the central unit, the signals from the sensors can be detected throughout the building ensuring essentially 100% coverage of the building.

The “ping” system ensures that the central unit is connected with all sensors, ensuring reliability day in and day out.

Programming of the system to detect low water usage events, such as weekend use in a office building, or in monitoring locations and sites which may be vacant for extended periods of time, can be achieved even in situations where no one is present in the building.

### BRIEF DESCRIPTION OF THE DRAWINGS

Embodiments of this invention will now be described by way of example only in association with the accompanying drawings in which:

FIG. 1 is a schematic drawing showing a building alarm monitoring system comprised of a series of sensor units that communicate with a central unit;

FIG. 2 is a flowchart of the use of the building alarm monitoring system to detect and respond to a water leak; and

FIG. 3 is a flowchart used to show a method for confirming the operational status of a sensor.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

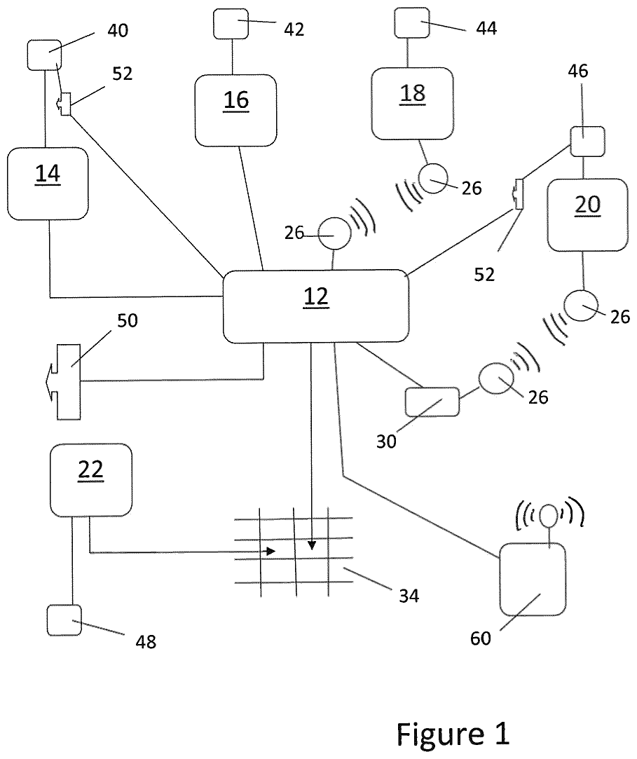

Referring to FIG. 1, the system of the present invention which is generally shown as “10”, includes a central unit 12 operatively connected to a plurality of sensor units 14, 16, 18, 20 and 22. The sensor can be any type of sensors, such as sensors to detect fire, smoke, gas leak, temperature variations, carbon monoxide, intrusion detection, and the like, but most preferably, as shown in FIG. 1, the sensors are used to detect a water leak. Also, the method of operation of the sensors to detect an anomalous condition is outside of the scope of the present invention. However, those skilled in the art would be well aware of the types of sensors available, and their operation.

Sensors 14 and 16 are hardwired to central unit 12 using wires. Sensor 18 is wirelessly connected to central unit 12 through two wireless transceivers 26 which are operatively connected to central unit 12 and to sensor 18. The wireless signal is sent to central unit 12 using these wireless transceivers 26.

Sensor 20 is a more distance wireless sensor that is in communication with central unit 12 through a repeater unit 30 which is hardwired to central unit 12, but also includes a wireless transceiver 26 which is adapted to receive signals from a further wireless transceiver 26 operatively connected to sensor 20.

Sensor 22 is connected to the building wiring system, generally shown as grid 34, and signals are sent over the grid from sensor 22. These signals are detected by central unit 12, which is also connected to grid 34.

Sensors 14, 16, 18, 20 and 22 are placed adjacent to potential water leak sources, such as a sink 40, a drain 42, a toilet 44, a basement sump pump 46 or a plumbing feature 48 such as a main water connection.

A central shutoff valve 50 can be provided to turn off the water to the entire building, if an anomalous condition (water leak) should be detected. Alternatively, or additionally, shutoff valves 52 can be placed at or near the water leak sources to turn off the water to that device only.

The central unit 12 can be powered by electrical energy from grid 34, but a battery back-up system (not shown) is preferably included as part of system 10.

The central unit is connected to a notification system 60 which is used to provide an alert or an alarm to the user if the system should detect a leak, or detect a malfunction of a sensor, or the like. The notification system 60 can be provided by one or more systems to allow notification by, for example, phone, cell phone, text messaging, e-mail, or the like. Preferably, the central unit provides the alert or alarm by at least two different methods, and preferably, to at least two different users or to a dedicated monitoring service.

When a sensor 14, 16, 18, 20 or 22 detects a water leak, as an anomalous condition, the sensor communicates with the central unit 12, to provide data on the sensor readings. The central unit then analyses the data to determine whether an anomalous condition does exist, and if so, the central unit 12 alerts the user with an alarm, and takes the appropriate action by activating at least one shutoff valve.

Preferably, the central unit is programmed to repeat the alert or alarm on a regular basis until the alert or alarm is acknowledged by the user.

Communication between the central unit 12 and sensors 14, 16, 18, 20 and 22 is preferably bi-directional meaning that signals can be sent from the sensors to the central unit, or from the central unit (e.g. as a “ping”) to the sensors.

The sensors 14, 16, 18, 20 and 22 can also include an ID signature as part of their signal, in order to clearly identify the appropriate sensor which is sending the signal. The central unit 12 can also include a table of ID locations to aid in specifically identifying the appropriate sensor or sensors. Communications between the central unit and the sensors can also include security protocols to avoid misuse of the signals between the two.

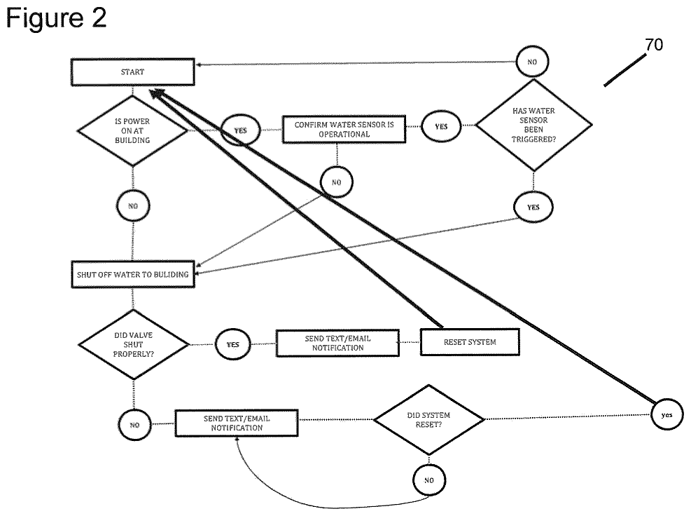

FIG. 2 is a flowchart “70” showing one embodiment of the operation of system 10 wherein the decision used by central unit 12 to detect and control water leaks in a building is shown. The operation of the system is as previously described hereinabove.

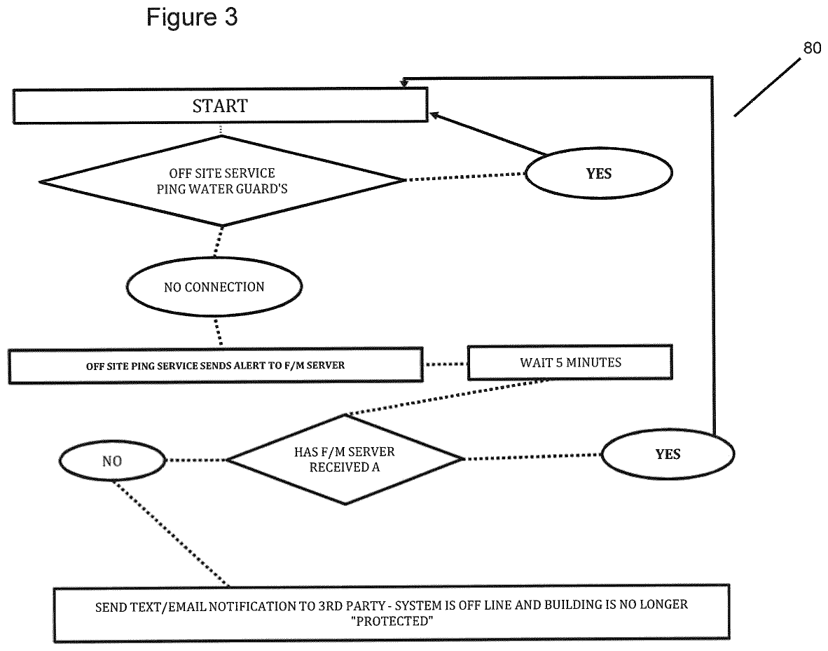

FIG. 3 is a flowchart “80” showing one embodiment of the operation of the sensor status monitoring system previously described, wherein the central unit 12 “pings” one or more sensors 14, 16, 18, 20 or 22, on a regular basis. Again, the operation of the system is as previously described hereinabove.

Thus, it is apparent that there has been provided, in accordance with the present invention, a building alarm monitoring system which fully satisfies the goals, objects, and advantages set forth hereinbefore, or inherent thereto. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practised in the absence of any element which is not specifically disclosed herein.

Moreover, words such as “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

1. A building alarm monitoring system comprising:
a central unit having a processor unit,
at least one sensor unit, and
at least one anomalous-condition response device, wherein the sensor unit is configured to:
measure a set condition for the building;
determine that an anomalous measurement is detected; and
notify the central unit of an anomalous condition,
and wherein said central unit is configured to receive a notice from the sensor regarding the anomalous condition, evaluate said anomalous condition to establish that an alarm condition exists, and determine that the anomalous condition is outside of an acceptable range of parameters so that an alarm condition exists, notify a user of the anomalous condition, and activate at least one anomalous-condition response device.

2. The system as claimed in claim 1 wherein said anomalous condition is a water leak.

3. The system as claimed in claim 2 wherein said system comprises a moisture sensor and/or a water level sensor; a connecting system to connect said sensors to said central unit; a processor which acts as said central unit, wherein said central unit is configured to collect sensor readings from said sensors; analyse said sensor readings to determine whether a water leak has been detected; and a reporting device so that a water leak has been detected by having a moisture level and/or a water level above a threshold valve, said central unit reports said water leak as an anomalous condition to a user as an alarm, and further activates said anomalous-condition response device.

4. The system as claimed in claim 3 where said connecting system is a wireless connection, or a hard-wired connection.

5. The system as claimed in claim 4 wherein said hard-wired connection utilizes the building wiring.

6. The system as claimed in claim 4 wherein said connecting system utilizes a local network established in said building.

7. The system of claim 3, wherein said moisture sensor and/or said water level sensor is placed proximate to a usage device.

8. The system of claim 7 wherein said usage device is a water supply pipe, a plumbing feature, a water heater, a toilet, or a water drain.

9. The system of claim 3 wherein said anomalous-condition response device is a water shutoff valve, and said central unit is configured to close said water shutoff valve when a water leak is detected.

10. The system of claim 9, further comprising means on said water shutoff valve for receiving instructions from said central unit to close said water shutoff valve when a leak is detected.

11. The system of claim 1 wherein said anomalous condition is an electrical failure.

12. The system of claim 10 wherein detection of said electrical failure is adapted to cause a water shutoff valve to activate.

13. The system of claim 12 wherein said water shutoff valve is battery operated.

14. The system of claim 1 wherein said anomalous condition is a gas leak detected by a flammable gas sensor.

15. The system of claim 14 wherein detection of a gas leak is adapted to cause a gas shutoff valve to activate.

16. The system of claim 1 wherein said anomalous condition is a refrigeration malfunction detected by using a temperature sensor.

17. (canceled)

18. The system of claim 16 wherein said refrigeration malfunction is adapted to cause a switch to disconnect power to said refrigeration device.

19. The system of claim 1, wherein said central unit is configured to notify a user by telephone, cellular telephone, text messaging, by pager, by email, or by Internet instant messaging.

20. The system of claim 1, wherein a central unit includes a monitoring feature which monitors the status of said sensor unit and said anomalous-condition response device.

21. A method for monitoring an alarm system comprising:
providing a building central alarm unit, at least one sensor unit, and at least one anomalous-condition response device, wherein the central alarm unit is operatively connected to the sensor units and the anomalous-condition response devices;
monitoring a set condition for the building;
determining that an anomalous measurement is detected;
notifying the central unit of an anomalous condition,
receiving, at the central unit, a notice from the sensor unit regarding the anomalous condition,
evaluate, at said central unit, said anomalous condition, to determine that said anomalous condition is outside of an acceptable range of parameters, and establish an alarm condition,
establishing that an alarm condition exists,
notifying a user of the alarm condition, and
activating at least one of the anomalous-condition response device.
